(19) United States
(12) Patent Application Publication
(10) Pub. No.: US 2003/0010931 A1
(43) Pub. Date: Jan. 16, 2003

(54) Methods for analyzing arrays

(76) Inventor: Richard J. Pittaro, San Carlos, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 09/906,362

(22) Filed: Jul. 16, 2001

(51) Int. Cl. G01N 21/64

(52) U.S. Cl. 250/459.1

(57) ABSTRACT

Methods and systems are disclosed for analyzing signals that exhibit time decay such as luminescent signals. The signal is detected using at least two predetermined integration periods that are offset by ninety degrees with respect to a fundamental excitation frequency. The characteristics of the signal are determined by processing the signals detected during the at least two integration periods. A surface comprising a plurality of signal producing features, such as an array of such features, may be analyzed in accordance with the present invention. Relatively inexpensive area sensor detectors may be employed in the analysis of such arrays.

### BACKGROUND OF THE INVENTION

This invention relates generally to the analysis of signals on the surface of a support or substrate having a plurality of features. In particular, the present invention relates to the analysis of signals involving the optical detection of fluorescent-labeled molecules or scattering structures.

Usually, the features comprise biopolymers and the signals are those that exhibit a change in fluorescent intensity or lifetime or both. The invention has particular application to the analysis of the results of hybridization reactions involving nucleic acids or for other fluorescence based assays such as those associated with blood gases, immuno-assays or proteins.

Determining the nucleotide sequences and expression levels of nucleic acids (DNA and RNA) is critical to understanding the function and control of genes and their relationship, for example, to disease discovery and disease management. Analysis of genetic information plays a crucial role in biological experimentation. This has become especially true with regard to studies directed at understanding the fundamental genetic and environmental factors associated with disease and the effects of potential therapeutic agents on the cell. Such a determination permits the early detection of infectious organisms such as bacteria, viruses, etc.; genetic diseases such as sickle cell anemia; and various cancers. This paradigm shift has lead to an increasing need within the life science industries for more sensitive, more accurate and higher-throughput technologies for performing analysis on genetic material obtained from a variety of biological sources.

Unique or misexpressed nucleotide sequences in a polynucleotide can be detected by hybridization with a nucleotide multimer, or oligonucleotide, probe.

Hybridization is based on complementary base pairing. When complementary single stranded nucleic acids are incubated together, the complementary base sequences pair to form double stranded hybrid molecules. These techniques rely upon the inherent ability of nucleic acids to form duplexes via hydrogen bonding according to Watson-Crick base-pairing rules. The ability of single stranded deoxyribonucleic acid (ssDNA) or ribonucleic acid (RNA) to form a hydrogen-bonded structure with a complementary nucleic acid sequence has been employed as an analytical tool in molecular biology research. An oligonucleotide probe employed in the detection is selected with a nucleotide sequence complementary, usually exactly complementary, to the nucleotide sequence in the target nucleic acid. Following hybridization of the probe with the target nucleic acid, any oligonucleotide probe/nucleic acid hybrids that have formed are typically separated from unhybridized probe. The amount of oligonucleotide probe in either of the two separated media is then tested to provide a qualitative or quantitative measurement of the amount of target nucleic acid originally present.

Direct detection of labeled target nucleic acid hybridized to surface-bound polynucleotide probes is particularly advantageous if the surface contains a mosaic of different probes that are individually localized to discrete, known areas of the surface. Such ordered arrays containing a large number of oligonucleotide probes have been developed as tools for high throughput analyses of genotype and gene expression. Oligonucleotides synthesized on a solid support recognize uniquely complementary nucleic acids by hybridization, and arrays can be designed to define specific target sequences, analyze gene expression patterns or identify specific allelic variations. The arrays may be microarrays created by in-situ synthesis, oligonucleotide deposition or cDNA. Due to the large number of genes in the human genome and other mammals and plants, it is desirable to automate this process.

In one approach, cell matter is lysed, to release its DNA as fragments, which are then separated out by electrophoresis or other means, and then tagged with a fluorescent or other label. The resulting DNA mix is exposed to an array of oligonucleotide probes, whereupon selective binding to matching probe sites takes place. The array is then washed and interrogated to determine the extent of hybridization reactions. In one approach the array is imaged so as to reveal for analysis and interpretation the sites where binding has occurred.

As mentioned above, in detection of polynucleotides a label is employed to detect the result of binding reactions. One type of label typically used produces a signal exhibiting change over time such as a decaying electromagnetic signal, for example, a luminescent signal, e.g., fluorescent signal. Results from the interrogation of a surface can be processed such as by rejecting a reading for a feature which is below a predetermined threshold and/or forming conclusions based on the pattern read from the array such as whether or not a particular target sequence may have been present in the sample.

Biological assays involving fluorescently labeled molecules or scattering structures to detect, quantify or identify target chemical species bound to surfaces often use optical detection and imaging systems. Arrays of different chemical probe species provide methods of highly parallel detection, and hence improved speed and efficiency, in assays. These arrays are, for example, DNA arrays and protein matrix arrays, which need to be scanned to measure the number densities of labeled molecules and hence the concentration of target or probe molecules in solution. This sensing process often is accomplished by means of an intensity-based scanning system such as that manufactured by Agilent Technologies Inc. On the other hand, the sensing process may be accomplished by means of an imaging array based system. For example, single channel systems capable of measuring fluorescent time decay or phase shift such as the SPEX Flourolog can be employed. Systems capable of time decay are generally not applicable to high throughput scanning. The above mentioned sensing systems are all relatively high cost.

It is desirable to be able to apply relatively low cost sensor technology in a multi-channel fluorescence measurement system capable of measuring time decay or phase shift. This also avoids amplitude sensitivity, which is found in most amplitude-based systems, i.e., systems that measure only the amplitude of a signal. One problem with such systems is that, if anything changes in the optical measurement path the amplitude of the signal is affected. Accordingly, the amplitude may not be based solely upon the signal generated by a particular event, but rather may be based on extraneous factors. The result is that such a measurement may not accurately reflect or be related to the amount of a particular substance under examination.

Another point of consideration particularly relates to the detection of biopolymers such as, for example, polynucleotides, e.g., DNA, RNA, etc. As indicated above, detection of such biopolymers often occurs on the surface of a support such as a glass support. Usually, such a support goes through a number of steps including contact with a sample solution, incubation, washing to remove unbound materials and the like prior to examining the surface for the presence of a signal. One problem that occurs is that a residue may remain on the surface of the support and this residue may generate, or exhibit a fluorescence of its own as in the case of much organic matter, producing a signal that is measured along with the signal that is generated by the presence of a signal producing feature on the surface of a support. For example, where fluorescent labels are employed, the surface may exhibit background fluorescence from residue of other matter on its surface or from the support or substrate itself. It is desirable to reduce or eliminate the effects of this background signal. One approach is to use a dye system that results in fluorescent energy transfer from one dye to another so that the emission that is read has a lifetime or wavelength that is much longer than that of the background residue.

### SUMMARY OF THE INVENTION

One embodiment of the present invention is a method for analyzing a fluorescent signal. The fluorescent signal is detected using at least two predetermined integration periods that are offset by ninety degrees with respect to a fundamental excitation frequency. The characteristics of the fluorescent signal are determined by processing the fluorescent signals detected during the at least two integration periods.

Another embodiment of the present invention is a method for analyzing signals on a surface comprising a plurality of signal producing features where the signals exhibit time decay. The signal producing features are activated and signal from each of the signal producing features is detected. The signal is detected using at least two predetermined integration periods that are offset by ninety degrees with respect to a fundamental activation frequency. The amount of the signal is determined by processing the signal detected during the at least two integration periods. In a specific embodiment the signal producing features are luminescent signal producing features.

Another embodiment of the present invention is a method for analyzing fluorescent signals on a surface, which comprises a plurality of fluorescent signal producing features. The fluorescent signal producing features are excited with a continuous wave fundamental excitation frequency. Fluorescent signal emission from each of the signal producing features is detected using at least two predetermined integration periods, I and Q, which are offset by ninety degrees with respect to the fundamental excitation frequency. The characteristics of the fluorescent signal are determined by processing the fluorescent signals detected during the at least two integration periods.

Another embodiment of the present invention is a computer program product comprising a computer readable storage medium having a computer program stored thereon which, when loaded into a computer, analyzes luminescent signals on a surface comprising a plurality of luminescent signal producing features. The computer program performs steps comprising (a) exciting under computer control the luminescent signal producing features, (b) detecting under computer control luminescent signal emitted from each of the signal producing features wherein the luminescent signal is detected using at least two predetermined integration periods that are offset by ninety degrees with respect to the fundamental excitation frequency employed in step (a), and (c) determining under computer control the characteristics of the luminescent signal by processing the luminescent signals detected during the at least two integration periods.

### BRIEF DESCRIPTION OF THE DRAWINGS

FIG. 1 is a schematic diagram depicting one embodiment of timing of integrations in accordance with the present invention.

FIG. 2 is a schematic diagram depicting an alternate embodiment of timing of integrations in accordance with the present invention.

FIG. 3 is a graph summarizing the results of a determination of amplitude of a signal in accordance with the present method.

FIG. 4 is a graph summarizing the results of a determination of phase of a signal in accordance with the present method.

FIG. 5 is a graph summarizing the results of a determination of a signal in accordance with the present method using a predetermined integration time that is one-third of the period of the excitation frequency.

### DETAILED DESCRIPTION OF THE INVENTION

The present invention provides for accurate analysis of signals on a surface comprising a plurality of such signals. The invention is directed to the manner of exciting, acquiring and processing such signals, which permits the use of relatively inexpensive area sensor detectors in such analysis. A support such as a chip that is designed for imaging may be employed using systems designed into the support. Signals are by activating signal producing features using a continuous wave function thereby driving phase information. Specific predetermined integration times are used that are related to the cycle of the frequency of excitation of the signals using certain offsets. The present method involves frequency spacing and phase spacing as discussed hereinbelow. Amplitude and phase measurements are calculated from the above information and these measurements are used to determine the presence and/or amount of an analyte such as a biopolymer.

In one aspect the present invention provides methods for analyzing signals on a surface comprising a plurality of signal producing features. The signals are those that exhibit change over time and usually are electromagnetic radiation signals. For example, the change in the signal may be a decrease or increase over time. The change is usually a change in emission properties such as intensity, and so forth. In one aspect the change in signal is decay of the signal over time. Of particular interest are luminescent signals such as, for example, fluorescent signals, chemiluminescent signals, electrochemiluminescent signals, quenchers capable of changing the emission properties of a luminescent label, and the like.

Fluorescent labels of interest generally are excited at a wavelength of about 350 to about 700 μm and emit light at a wavelength above about 350 μm, usually above about 400 nm, more usually, about 450 to about 800 nm. Desirably, the fluorescent compounds have high quantum efficiency, a large Stokes shift and are chemically stable under the conditions of their use.

Fluorescers of interest fall into a variety of categories having certain primary functionalities. These primary functionalities include 1- and 2-aminonaphthalene, p,p-diaminostilbenes, pyrenes, quaternary phenanthridine salts, 9-aminoacridines, imines, anthracenes, oxacarboxyamine, merocyanine, 3-aminoequilenin, perylene, bis-benzoxazole, bis-p-oxazolyl benzene, 1,2-benzophenazine, retinal, bis-3-aminopyridinium salts, hellebrigenin, tetracycline, sterophenol, benzimidazolylphenylamine, 2-oxo-3-chromen, indole, xanthene, 7-hydroxycoumarin, 4,5-benzimidazoles, phenoxazine, salicylate, strophanthidin, porphyrins, triarylmethanes, flavin and rare earth chelates oxides and salts. Fluorescent labels are of particular interest and are well known in the art. Typical fluorescent labels include xanthenes such as fluorescein, rhodamine, and their derivatives, coumarins such as umbelliferone, bimanes, cyanines, oxazines, phthalocyanines, phycobiliproteins, squaraines, and the like.

Chemiluminescent labels include cyclic and acyclic acylhydrazides such as luminol, natural and synthetic luciferins, acridium esters, dioxetanes, oxylate ester, etc. Electroluminescent labels may be, for example, ruthenium chelates and the like. Quenchers which are frequently used in combination with a fluorescer for fluorescence resonance energy transfer detection are likewise well known in the art and include any of the aforementioned fluorescent labels, non-fluorescent dyes such as DABCYL, hydroxyfluoresceins, azo-compounds, electron donors such as anilines and other amines, electron acceptors such as quinones, and the like.

The surface comprising a plurality of signal producing features is generally the surface of a support, which is usually a porous or non-porous water insoluble material. In one embodiment the surface comprises a plurality of biopolymers attached to the surface. The support can have any one of a number of shapes, such as strip, plate, disk, rod, particle, and the like. The support can be hydrophilic or capable of being rendered hydrophilic. The support is usually glass such as flat glass whose surface has been chemically activated to permit binding or synthesis of biopolymers such as polynucleotides, glass available as Bioglass and the like. However, the support may be made from materials such as inorganic powders, e.g., silica, magnesium sulfate, and alumina; natural polymeric materials, particularly cellulosic materials and materials derived from cellulose, such as fiber containing papers, e.g., filter paper, chromatographic paper, etc.; synthetic or modified naturally occurring polymers, such as nitrocellulose, cellulose acetate, poly (vinyl chloride), polyacrylamide, cross linked dextran, agarose, polyacrylate, polyethylene, polypropylene, poly(4-methylbutene), polystyrene, polymethacrylate, poly(ethylene terephthalate), nylon, poly(vinyl butyrate), etc.; either used by themselves or in conjunction with other materials; ceramics, metals, and the like. Binding of oligonucleotides to a support or surface may be accomplished by well-known techniques, commonly available in the literature. See, for example, A. C. Pease, et al., Proc. Nat. Acad. Sci. USA, 91:5022-5026 (1994).

The support may be located within a housing, which typically includes a body having a reaction cavity disposed therein. The support is mounted over the cavity on the body such that the side of the support on which signal producing features are present is in fluid communication with the cavity. The bottom of the cavity may optionally include a light absorptive material, such as a glass filter or carbon dye, to prevent impinging light from being scattered or reflected during imaging by detection systems. The housing usually further comprises fluid inlets and fluid outlets for flowing fluids into and through the cavity. A septum, plug or other seal may be employed across the inlets and/or outlets to seal the fluids in the cavity. In addition to the fluid inlets and outlets, the housing typically comprises an opening for accessing the interior of the cavity. This opening is sealed with a cover. Various embodiments of support housings are known in the art.

The apparatus and methods of the present invention are particularly useful in the area of analysis of arrays of biopolymers. A biopolymer is a polymer of one or more types of repeating units relating to biology. Biopolymers are typically found in biological systems (although they may be made synthetically) and particularly include peptides or polynucleotides, as well as such compounds composed of or containing amino acid analogs or non-amino acid groups, or nucleotide analogs or non-nucleotide groups. This includes polynucleotides in which the conventional backbone has been replaced with a non-naturally occurring or synthetic backbone, and nucleic acids (or synthetic or naturally occurring analogs) in which one or more of the conventional bases has been replaced with a group (natural or synthetic) capable of participating in Watson-1o Crick type hydrogen bonding interactions.

An array includes any one, two or three-dimensional arrangement of addressable regions bearing a particular biopolymer such as polynucleotides, associated with that region. An array is addressable in that it has multiple regions of different moieties, for example, different polynucleotide sequences, such that a region or feature or spot of the array at a particular predetermined location or address on the array can detect a particular target molecule or class of target molecules although a feature may incidentally detect non-target molecules of that feature.

The apparatus and methods of the present invention are particularly useful in the area of analysis of oligonucleotide arrays for determinations of polynucleotides. In the field of bioscience, arrays of oligonucleotide probes, fabricated or deposited on a surface of a support, are used to identify DNA sequences in cell matter. The arrays generally involve a surface containing a mosaic of different oligonucleotides or sample nucleic acid sequences or polynucleotides that are individually localized to discrete, known areas of the surface. In one approach, multiple identical arrays across a complete front surface of a single substrate or support are used. However, the arrays produced on a given substrate need not be identical and some or all could be different. Each array may contain multiple spots or features and each array may be separated by spaces. Each feature, or element, within the molecular array is defined to be a small, regularly shaped region of the surface of the substrate. The features are arranged in a regular pattern. Each feature within the molecular array may contain a different molecular species, and the molecular species within a given feature may differ from the molecular species within the remaining features of the molecular array. A typical array may contain from about 100 to about 100,000 or more features. All of the features may be different, or some or all may be the same. Each feature may carry a predetermined polynucleotide having a particular sequence or a predetermined mixture of polynucleotides. While arrays may be separated from one another by spaces, and the features may be separated from one another by spaces, such spaces in either instance are not essential.

Ordered arrays containing a large number of oligonucleotides have been developed as tools for high throughput analyses of genotype and gene expression. Oligonucleotides synthesized on a solid support recognize uniquely complementary nucleic acids by hybridization, and arrays can be designed to define specific target sequences, analyze gene expression patterns or identify specific allelic variations. The arrays may be used for conducting cell study, for diagnosing disease, identifying gene expression, monitoring drug response, determination of viral load, identifying genetic polymorphisms, analyze gene expression patterns or identify specific allelic variations, and the like.

Oligonucleotide probes are oligonucleotides employed to bind to a portion of a polynucleotide such as another oligonucleotide or a target polynucleotide sequence. Usually, the oligonucleotide probe is comprised of natural nucleotides such as ribonucleotides and deoxyribonucleotides and their derivatives although unnatural nucleotide mimetics such as 2′-modified nucleosides, peptide nucleic acids and oligomeric nucleoside phosphonates are also used. The design, including the length, and the preparation of the oligonucleotide probes are generally dependent upon the sequence to which they bind. Usually, the oligonucleotide probes are at least about 2 nucleotides, preferably, about 5 to about 100 nucleotides, more preferably, about 10 to about 50 nucleotides, and usually, about 15 to about 30 nucleotides, in length.

Polynucleotides are compounds or compositions that are polymeric nucleotides or nucleic acid polymers. The polynucleotide may be a natural compound or a synthetic compound. The polynucleotides include nucleic acids, and fragments thereof, from any source in purified or unpurified form including DNA (dsDNA and ssDNA) and RNA, including tRNA, mRNA, rRNA, mitochondrial DNA and RNA, chloroplast DNA and RNA, DNA/RNA hybrids, or mixtures thereof, genes, chromosomes, plasmids, cosmids, the genomes of biological material such as microorganisms, e.g., bacteria, yeasts, phage, chromosomes, viruses, viroids, molds, fungi, plants, animals, humans, and the like. The polynucleotide can be only a minor fraction of a complex mixture such as a biological sample. Also included are genes, such as hemoglobin gene for sickle-cell anemia, cystic fibrosis gene, oncogenes, cDNA, and the like. The polynucleotide can be obtained from various biological materials by procedures well known in the art. A target polynucleotide sequence is a sequence of nucleotides to be identified, detected or otherwise analyzed, usually existing within a portion or all of a polynucleotide.

Various ways may be employed to produce an array of polynucleotides on surfaces of supports such as glass, metal, plastic and the like. Such methods are known in the art. One such method is discussed in U.S. Pat. No. 5,744,305 (Fodor, et al.) and involves solid phase chemistry, photolabile protecting groups and photolithography. Binary masking techniques are employed in one embodiment of the above. In another approach ink jet technology may be used to spot polynucleotides and other reagents on a surface as described, for example, in PCT application WO 89/10977. Other methods include those disclosed by Gamble, et al., WO97/44134; Gamble, et al., WO98/10858; Baldeschwieler, et al., WO95125116; Brown, et al., U.S. Pat. No. 5,807,522; and the like.

Commonly, in polynucleotide detection binding of an oligonucleotide probe to a target polynucleotide sequence is detected by means of a label incorporated into the target. Alternatively, the target polynucleotide sequence may be unlabeled and a second oligonucleotide probe may be labeled. Binding can be detected by separating the bound second oligonucleotide probe or target polynucleotide from the free second oligonucleotide probe or target polynucleotide and detecting the label. In one approach, a sandwich is formed comprised of one oligonucleotide probe, which may be labeled, the target polynucleotide and an oligonucleotide probe that is or can become bound to a surface of a support. Alternatively, binding can be detected by a change in the signal-producing properties of the label upon binding, such as a change in the emission efficiency of a fluorescent or chemiluminescent label. This permits detection to be carried out without a separation step. Finally, binding can be detected by labeling the target polynucleotide, allowing the target polynucleotide to hybridize to a surface-bound oligonucleotide probe, washing away the unbound target polynucleotide and detecting the labeled target polynucleotide that remains. Direct detection of labeled target polynucleotide hybridized to surface-bound oligonucleotide probes is particularly advantageous in the use of ordered arrays.

In analyses utilizing arrays on supports such as described above, the presence of labels on the surface of the support by virtue of the occurrence of binding events involving target molecules results in signal producing features on the surface of the support. As mentioned above, the present invention has particular application to labels whose signals exhibit time decay. The plurality of signal producing features on the surface of a support as the result of an assay must be analyzed in order to determine the results of the assay, i.e., the presence and/or amount of one or more target molecules.

Generally, in accordance with the present invention, an initial step in the analysis of the features on the surface of a support involves activating the signal producing features. The nature of the activation is directly related to the nature of the label employed at the feature and is related to the nature of the signal that will be produced at the feature. Luminescent labels that are photoactive are usually irradiated with light. The wavelength of irradiation is generally determined by the excitation wavelength of the luminescent label. Irradiation may be by means of any appropriate light source such as a laser, Led, tungsten lamp and the like. The excitation light source may be subjected to one or more filters to isolate radiation of the excitation source. In general, a filter may be a highpass filter, or a band stop filter to exclude wavelengths that are outside of such absorption band. In accordance with the present invention the excitation source is a continuous wave or function as opposed to pulsed irradiation. This may be explained more fully as follows. Rather than exiting the sample with a single pulse and measuring the time decay or other transient parameter, the sample is exited with a continuous wave (CW) signal. A steady state parameter such as phase shift or amplitude is then measured. The continuous wave may be, for example, square wave, sine wave, triangle wave and the like. The fundamental excitation frequency of these waveforms is defined by Fourier methods.

The signal from each of the signal producing features is acquired and detected. Normally, an interrogation device is used to examine the surface of a support for the presence and amount of signal after a reaction has taken place. The interrogation device may be a scanning device involving an optical system. In common optical analysis techniques, a tightly focused or pinpoint laser beam scans the surface of the support in order to excite labels such as fluorophores, which may be present on the surface of the support. Then, emissions from the labels are analyzed by means of an optical measuring device. A laser scanner may be used to scan the surface of the support. The scanner is able to read the location and intensity of signal at each feature of an array following exposure of the array to a labeled sample sample. Results from the interrogation can be processed such as by rejecting a reading for a feature, which is below a predetermined threshold and/or forming conclusions based on the pattern read from the array such as whether or not a particular target sequence may have been present in the sample.

Desirably, in the present invention the signal is acquired and detected using an area sensor detector, such as, for example, an area sensor detector manufactured by Agilent Technologies Inc., Model HD 1020 and so forth. One type of area sensor detector for use in the present methods involves imaging technology, preferably, inexpensive imaging technology. As discussed more fully below the signal may be detected by technologies such as charge-coupled devices (CCD), CMOS devices, and so forth.

In one approach luminescent radiation may be imaged onto a two dimensional array of a CCD of the type used as the retina in industrial and commercial solid state video cameras. These are readily available through commercial supply channels. It has been recognized that the way that a CCD camera is operated is especially adapted for use in making measurements of the decay time of luminescent radiation that strikes it. Each photosite of the array can integrate the amount of electronic charge that is generated by incident light during a single video frame. The signal may be integrated in accordance with the present invention in successive video frames. An excitation source directs continuous wave radiation against the luminescent material with a timing that is precisely synchronized to the frame rate of the CCD camera. A CCD instrument for carrying out the above is disclosed in U.S. Pat. No. 5,304,809 (Wickersheim), the relevant disclosure of which is incorporated herein by reference.

Low cost detectors that utilize low cost CMOS detectors are also becoming readily available. Any such detector that provides provision for shutter control may be utilized to accomplish the methods of the present invention.

In accordance with the present invention, the features to be measured are excited with a continuous wave excitation and the signal is detected using at least two predetermined integration times that are offset or delayed by ninety degrees with respect to the excitation frequency. The integration is performed by the particular technology used for detecting the signal. Usually, the predetermined integration time is a predetermined fraction of the cycle of the signal emission. The integration times may be set in, and controlled by, the acquisition technology in accordance with the principles of such technology. Accordingly, the desired predetermined integration time is selected and the acquisition technology is then set to acquire signal using the predetermined integration time.

As mentioned above, the predetermined integration time is usually set for a predetermined fraction of the period or cycle of the signal emission. The period may be any non-integral period of the excitation waveform, but preferably a fraction thereof. The predetermined integration time is usually about one quarter to about one half the period of the excitation signal. As explained more fully below, a preferred fraction is one-third of the period or cycle of the signal emission.

In the present method at least two integrations, I and Q, are performed in which the integrations are delayed or offset by 90 degrees with respect to the fundamental excitation frequency. The I integration is at a particular phase, Θ, which is arbitrarily selected and fixed relative to 0 phase. Integration from 0 to T is performed at this phase. The Q integration is the same as I except that there is a shift by 90 degrees versus I with respect to the fundamental excitation frequency.

The following equations assist in further understanding of the above.

$$I = \frac{1}{T} \cdot {\int }_{0}^{T} ( sin ( 2 \cdot π \cdot f \cdot t + Θ ) + 1 ) ⅆ t$$

wherein T is integration time, f is the frequency of excitation wavelength, t is time from point of activation and θ is an arbitrary constant, indicating that the integration may be initiated at any phase with respect to the excitation waveform, but constant for both I and Q described below.

$$Q = \frac{1}{T} \cdot {\int }_{0}^{T} ( sin ( 2 \cdot π \cdot f \cdot t + Θ + \frac{π}{2} ) + 1 ) ⅆ t$$

wherein T, f, t and θ are as described above for I. As can be seen, Q is offset from I by 90 degrees with respect to the excitation frequency as is evident from the “π/2” in the above equation for Q when compared to the corresponding equation for I.

The amplitude or maximum displacement of the signal emission wave is then determined by calculating the square root of the sum of the squares with respect to the I and Q measurement values. The measured amplitude (Z) is attenuated relative to the amplitude that would be measured using standard (non-integrating) sampling techniques. The attenuation is determined by the integration period. This can be described as a “Sinc” filter as described in FIG. 5. The aforementioned determination of amplitude is set forth by the following equation:

z=\sqrt{Q²+I²}

wherein z is the amplitude and I and Q are as discussed above.

The phase of the signal emission relative to a reference is determined by calculating the arctangent (atan) of the quotient of the I and Q measurement values. The phase is offset by a constant that is also dependent on the predetermined integration time. The aforementioned determination of phase may be represented by the following equation:

$$p h = a tan ( \frac{I}{Q} )$$

Both the amplitude and phase determinations are carried out by the signal processing technology, which is part of the signal detection apparatus.

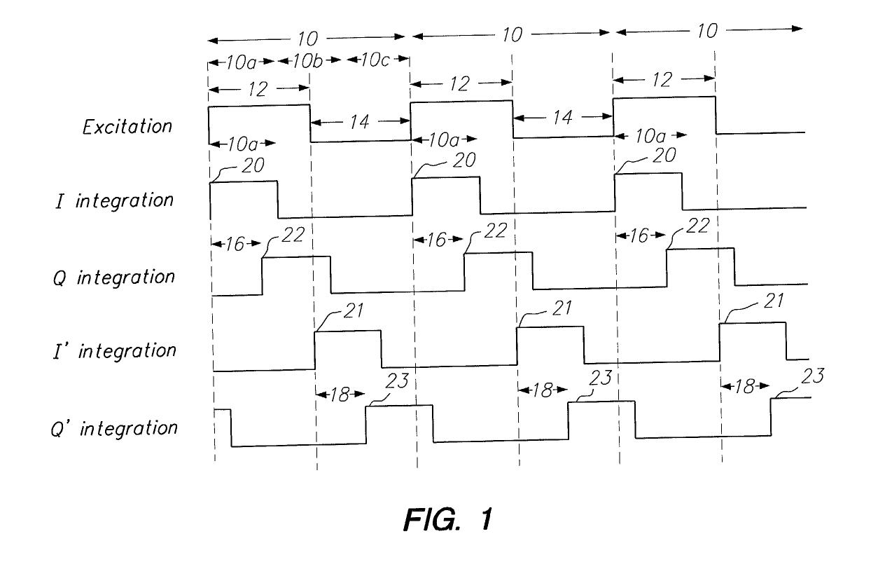

In a particular embodiment of the present invention, each signal emitted is detected using four predetermined integration times, I and Q and I′ and Q′. This embodiment is explained more fully below with reference to FIG. 1. In each set of I and Q, the two integration times are offset by ninety degrees with respect to the excitation frequency cycle employed. Referring to FIG. 1, a series of excitation frequency cycles 10 are depicted. Each cycle is comprised of an on portion 12 and an off portion 14. I and Q and I′ and Q′ are offset by ninety degrees, respectively 16 and 18 in FIG. 1, with respect to the excitation frequency cycle 10. The start 20 and start 21, respectively, of each of predetermined integration times I and I′ are 180 degrees apart and the start 22 and start 23, respectively, of each of predetermined integration times Q and Q′ are also 180 degrees apart.

In accordance with the present invention the I′ value is subtracted from the I value and the Q′ value is subtracted from the Q value. The resulting values are then employed in the determination of amplitude and phase as discussed above. In this way certain offset errors may be suppressed or eliminated. Such offset errors include, for example, fixed pattern noise, dc component of the detected optical signal, DC offsets in amplifiers, A/d converters and any other conditioning circuitry, and so forth. It should be noted that, assuming a steady state, the I and Q readings do not have to be taken in the same cycle as long as the readings are synchronous. One can acquire a number of I readings followed by a number of I′ readings. A similar situation applies to the Q and Q′ readings. It is evident from the above that a number of predetermined integration times employed may be summed or averaged before calculating the amplitude and phase or the results of a number or the calculated results may be averaged also reducing noise. Assuming the noise is random, the noise would be reduced by the square root of the number of readings averaged.

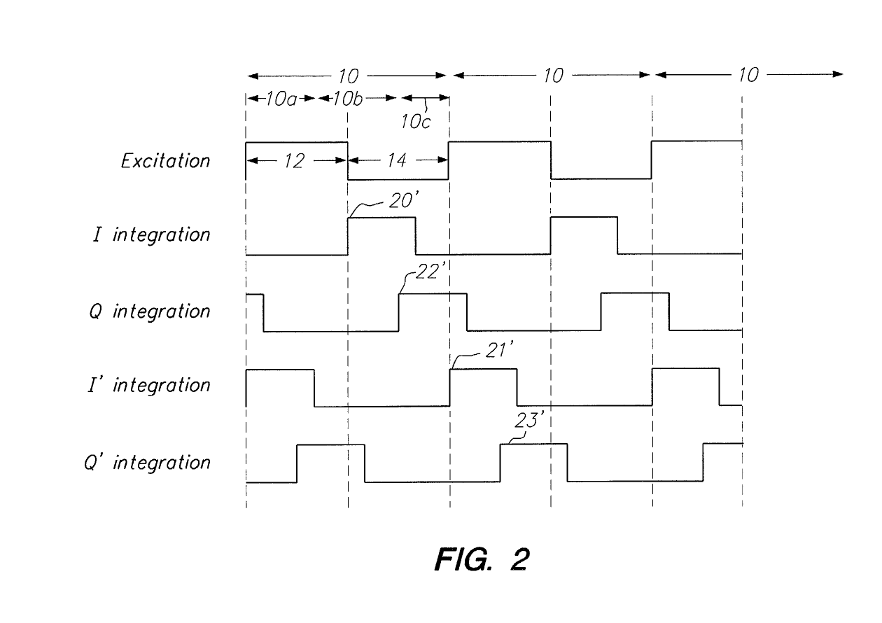

It should also be noted that the start times for the I integrations need not coincide with the start time of the excitation frequency cycle. The start times for the I integrations may occur at any point along the excitation frequency cycle as long as the Q integrations are offset from the I integrations by 90 degrees with respect to the excitation frequency cycle. The above applied as well to the I′ and Q′ integrations as long as I′ is offset from I and Q′ is offset from Q by 180 degrees. For example, referring to FIG. 2 the start time 20′ for the I integration coincides with the start time of the off 14 of excitation frequency cycle 10. The relationships between I and Q and I and I′ and Q and Q′ are as described above except that each starts at a different point on the excitation frequency cycle 10 as determined by the start time 20′ for the I integration.

Additional benefits may be realized by selection of the predetermined integration time. If one-third of the period of the measured waveform is used as the predetermined integration time, errors due to harmonics of the measured waveform can be suppressed. Referring to FIG. 1, the I integration is one-third (10a) of the excitation frequency cycle 10, which comprises 10a, 10b, and 10c. Similarly, the I′ integration is one-third of the excitation frequency cycle 10. Furthermore, each Q and Q′ integration time is one-third of the excitation frequency cycle 10. By using an integration time of one-third of the excitation frequency cycle, for example, errors that would be present if a square wave excitation function were utilized are minimized. This results in a simplification of drive circuitry because simple switching circuitry can be employed to generate the square wave and the filtering effect produced by the ⅓ period integration time will completely eliminate the third harmonic and provide substantial filtering of the higher order harmonics (5th, 7^{th}, etc) present in the square wave excitation.

The following mathematical formulations assist in further understanding the aforementioned embodiment. Two integrations, I and I′, are performed in accordance with the present invention. I and I′ are offset by 180 degrees as can be seen by the presence of “π” in the right equation on the second line when compared to the left equation on the second line. I′ is subtracted from I:

$$I - {I}^{′}$$

$$I = \frac{1}{T} \cdot {\int }_{0}^{T} ( sin ( 2 \cdot π \cdot f \cdot t + Θ ) + 1 ) ⅆ t - \frac{1}{T} \cdot {\int }_{0}^{T} ( sin ( 2 \cdot π \cdot f \cdot t + Θ + π ) + 1 ) ⅆ t$$

$$\frac{1}{T} \cdot [ \frac{1}{2} \cdot \frac{( - cos ( 2 \cdot π \cdot f \cdot T + Θ ) + 2 \cdot π \cdot f \cdot T )}{( π \cdot f )} + \frac{1}{2} \cdot \frac{cos ( Θ )}{( π \cdot f )} ] - \frac{1}{T} \cdot [ \frac{1}{2} \cdot \frac{( - cos ( 2 \cdot π \cdot f \cdot T + Θ ) + 2 \cdot π \cdot f \cdot T )}{( π \cdot f )} + \frac{1}{2} \cdot \frac{cos ( Θ )}{( π \cdot f )} ]$$

$$\frac{( - cos ( 2 \cdot π \cdot f \cdot T + Θ ) + \cdot cos ( Θ ) )}{( π \cdot ( f \cdot T ) )}$$

Two additional integrations, Q and Q′, are performed in accordance with the present invention. Q and Q′ are offset from I and I′, respectively, by 90 degrees with respect to the excitation frequency as is evident from the “π/2” in the following equations when compared to the corresponding equations for I and I′. In addition, Q and Q′ are offset from each other by 180 degrees as can be seen by the presence of an additional “π” in the right equation on the second line exhibiting “3π/2” when compared to the left equation on the second line exhibiting “π/2”. Q′ is subtracted from Q:

$$Q - {Q}^{′}$$

$$\frac{1}{T} \cdot {\int }_{0}^{T} ( sin ( 2 \cdot π \cdot f \cdot t + Θ + \frac{π}{2} ) + 1 ) ⅆ t - \frac{1}{T} \cdot {\int }_{0}^{T} ( sin ( 2 \cdot π \cdot f \cdot t + Θ + 3 \frac{π}{2} ) + 1 ) ⅆ t$$

$$\frac{1}{T} \cdot [ \frac{1}{2} \cdot \frac{( sin ( 2 \cdot π \cdot f \cdot T + Θ ) + 2 \cdot π \cdot f \cdot T )}{( π \cdot f )} + \frac{1}{2} \cdot \frac{cos ( Θ )}{( π \cdot f )} ] - \frac{1}{T} \cdot [ \frac{1}{2} \cdot \frac{( - sin ( 2 \cdot π \cdot f \cdot T + Θ ) + 2 \cdot π \cdot f \cdot T )}{( π \cdot f )} + \frac{1}{2} \cdot \frac{sin ( Θ )}{( π \cdot f )} ]$$

$$\frac{- ( - sin ( 2 \cdot π \cdot f \cdot T + Θ ) + \cdot sin ( Θ ) )}{( π \cdot ( f \cdot T ) )}$$

Next, the amplitude and the phase are calculated as follows wherein t:=1 and T:=⅓·f

$$I ( Θ ) := \frac{( - cos ( 2 \cdot π \cdot f \cdot T + Θ ) + \cdot cos ( Θ ) )}{( π \cdot ( f \cdot T ) )}$$

$$Q ( Θ ) := \frac{- ( - sin ( 2 \cdot π \cdot f \cdot T + Θ ) + sin ( Θ ) )}{( π \cdot ( f \cdot T ) )}$$

$$z ( Θ ) := \sqrt{{Q ( Θ )}^{2} = {I ( Θ )}^{2}}$$

$$p h ( Θ ) := a tan ( \frac{I ( Θ )}{Q ( Θ )} )$$

$$( Θ ) := - 0 , \frac{π}{50} \cdot \cdot 2 \cdot π$$

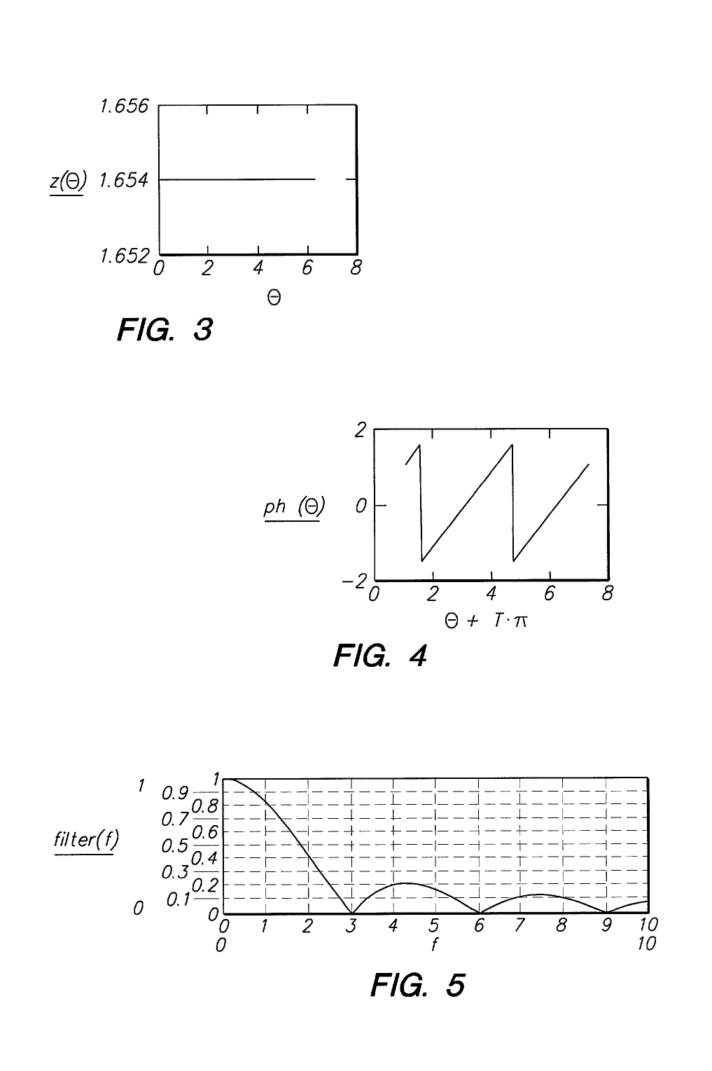

Referring to FIGS. 3 and 4, the above results demonstrate that the calculated amplitude z is independent of phase. Furthermore, the predetermined integration time that is one-third of the period of the measured waveform yields a scaling factor of 1.654. The calculated phase plotted against the actual phase shows no scaling error with a fixed offset equivalent to a phase shift of half of the integration time. Of course, other integration times based on other fractions of the period of the measured waveform may be utilized yielding different scaling factors and phase offsets. However, the integration time that is one-third of the period of the measured waveform is preferred in this situation because it reduces errors when used with square wave excitation and provides for some low pass filtering and does not attenuate the signal significantly as evidenced by the 1.6 scaling factor. A scaling factor of 2.0 would be the scaling factor where no integration in accordance with the present invention was performed. The scaling factor of 2 comes from subtracting I′ from 1 and Q′ from Q thereby doubling the signal

FIG. 5 is a plot for the low pass filter function using a predetermined integration time that is one-third of the period of the measured waveform. FIG. 5 represents the transfer function of the filter function consistent with the integration period being ⅓ the period of the excitation waveform. This function is recognized as a Sinc function with a zero transmission at 3f, i.e., the third harmonic of the excitation waveform.

As mentioned above, one problem that occurs with supports that are utilized in assay methods is that a residue may remain on the surface of the support. This residue may generate a signal that is measured along with the signal that is generated by the presence of a signal producing feature on the surface of a support. For example, where fluorescent labels are employed, the surface may exhibit background fluorescence from residue of other matter on its surface. The present invention may be used to reduce or eliminate the effects of this background signal. To this end, in one embodiment of the present invention, the start of the integration periods occurs during a predetermined fraction of the cycle of the luminescent signal emission and is selected to obtain a vector wherein the contribution of I to the vector is maximized and the contribution of Q to the vector is minimized. Accordingly, a phase shift may be employed in the method of the invention to maximize the contribution of I to the vector, which is desirable because it has none of the instantaneous components of the signal emission such as background interference. Therefore, since any contribution to the signal by background is found in the Q component of the vector, background interference is essentially eliminated.

The methods in accordance with the present invention may be carried out under computer control, that is, with the aid of a computer. For example, an IBM® compatible personal computer (PC) may be utilized. The computer is driven by software specific to the methods described herein. A preferred computer hardware capable of assisting in the operation of the methods in accordance with the present invention involves a system with at least the following specifications: Pentium® processor or better with a clock speed of at least 100 MHz, at least 32 megabytes of random access memory (RAM) and at least 80 megabytes of virtual memory, running under either the Windows 95 or Windows NT 4.0 operating system (or successor thereof).

Software that may be used to carry out the methods may be, for example, Microsoft Excel or Microsoft Access, suitably extended via user-written functions and templates, and linked when necessary to stand-alone programs that perform homology searches or sequence manipulations. A computer program product may comprise a computer readable storage medium having a computer program stored thereon which, when loaded into a computer, analyzes signals on a surface comprising a plurality of signal producing features. Examples of software or computer programs used in assisting in conducting the present methods may be written, preferably, in Visual BASIC, FORTRAN and C⁺⁺, as exemplified below in the Examples. It should be understood that the above computer information and the software used herein are by way of example and not limitation. The present methods may be adapted to other computers and software. Other languages that may be used include, for example, PASCAL, PERL or assembly language.

As indicated above, a computer program may be utilized to carry out the above method steps. The computer program provides for (i) exciting under computer control the signal producing features, (ii) detecting under computer control signal emitted from each of signal producing features wherein the signal is detected using at least two predetermined integration periods that are offset by ninety degrees with respect to the fundamental excitation frequency employed above, and (iii) determining under computer control the characteristics of the signal by processing the signals detected during the at least two integration periods. The processing of the signals may also be carried out under computer control. In that regard the computer program calculates the square root of the sum of the squares to determine the amplitude of the signal and calculates the arctangent of the quotient of I and Q to determine the phase of the signal. An area sensor detector to detect the signals also may be operated under computer control.

Another aspect of the present invention is a computer program product comprising a computer readable storage medium having a computer program stored thereon which, when loaded into a computer, performs the aforementioned method.

All publications and patent applications cited in this specification are herein incorporated by reference as if each individual publication or patent application were specifically and individually indicated to be incorporated by reference.

Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the appended claims.

What is claimed is:

1. A method for analyzing a fluorescent signal, said method comprising:
(a) detecting said fluorescent signal using at least two predetermined integration periods that are offset by ninety degrees with respect to a fundamental excitation frequency, and
(b) determining the characteristics of said fluorescent signal by processing said fluorescent signals detected during said at least two integration periods.

2. A method for analyzing signals on a surface comprising a plurality of signal producing features, said signals exhibiting time decay, said method comprising:
(a) activating said signal producing features,
(b) detecting signal from each of said signal producing features wherein said signal is detected using at least two predetermined integration periods that are offset by ninety degrees with respect to a fundamental activation frequency, and
(c) determining the amount of said signal by processing the signal detected during said at least two integration periods.

3. A method for analyzing luminescent signals on a surface comprising a plurality of luminescent signal producing features, said method comprising:
(a) exciting said luminescent signal producing features,
(b) detecting luminescent signal emission from each of said signal producing features wherein said luminescent signal is detected using at least two predetermined integration periods, I and Q, that are offset by ninety degrees with respect to the fundamental excitation frequency, and
(c) determining the characteristics of said luminescent signal by processing said luminescent signals detected during said at least two integration periods.

4. A method according to claim 3 wherein the start of said integration periods occurs during a predetermined fraction of the cycle of said luminescent signal emission.

5. A method according to claim 3 wherein said processing of said luminescent signals is carried out by calculating the square root of the sum of the squares to determine the amplitude of said luminescent signal and calculating the arctangent of the quotient of I and Q to determine the phase of said luminescent signal.

6. A method according to claim 3 wherein each of said luminescent signal emissions is detected using four predetermined integration periods, I and I′ and Q and Q′, wherein I and Q and I′ and Q′ are offset by ninety degrees with respect to the excitation frequency employed and wherein I and I′ are 180 degrees apart and Q and Q′ are 180 degrees apart.

7. A method according to claim 6 wherein an initial step of said processing comprises subtracting I′ from I and subtracting Q′ from Q.

8. A method according to claim 3 wherein said luminescent signals are detected by an area sensor detector.

9. A method according to claim 1 wherein the start of said integration periods occurs during a predetermined fraction of the cycle of said luminescent signal emission and is selected to obtain a vector wherein the contribution of I to said vector is maximized and the contribution of Q to said vector is minimized.

10. A method for analyzing fluorescent signals on a surface comprising a plurality of fluorescent signal producing features, said method comprising:
(a) exciting said fluorescent signal producing features with a continuous wave fundamental excitation frequency,
(b) detecting fluorescent signal emission from each of said signal producing features wherein said fluorescent signal is detected using at least two predetermined integration periods, I and Q, which are offset by ninety degrees with respect to the fundamental excitation frequency, and
(c) determining the characteristics of said fluorescent signal by processing said fluorescent signals detected during said at least two integration periods.

11. A method according to claim 10 wherein said fluorescent signal producing features are excited by irradiating said features with light.

12. A method according to claim 10 wherein said surface comprises an array of said fluorescent signal producing features.

13. A method according to claim 10 wherein the start of said integration periods occurs during a predetermined fraction of the cycle of said fluorescent signal emission.

14. A method according to claim 13 wherein said predetermined fraction is one quarter to three quarters.

15. A method according to claim 13 wherein said predetermined fraction is one third.

16. A method according to claim 10 wherein said characteristics determined in step (c) are amplitude and phase.

17. A method according to claim 10 wherein said processing of said fluorescent signals is carried out by calculating the square root of the sum of the squares to determine the amplitude of said fluorescent signal and calculating the arctangent of the quotient of I and Q to determine the phase of said fluorescent signal.

18. A method according to claim 10 wherein each of said luminescent signal emissions is detected using four predetermined integration periods, I and I′ and Q and Q′, wherein I and Q and I′ and Q′ are offset by ninety degrees with respect to the excitation frequency employed and wherein I and I′ are 180 degrees apart and Q and Q′ are 180 degrees apart.

19. A method according to claim 18 wherein an initial step of said processing comprises subtracting I′ from I and subtracting Q′ from Q.

20. A method according to claim 10 wherein said fluorescent signals are detected by an area sensor detector.

21. A method according to claim 20 wherein said area sensor detector is selected from the group consisting of CCD detectors and CMOS detectors.

22. A method according to claim 10 wherein the start of said integration periods occurs during a predetermined fraction of the cycle of said luminescent signal emission and is selected to obtain a vector wherein the contribution of I to said vector is maximized and the contribution of Q to said vector is minimized.

23. A computer program product comprising a computer readable storage medium having a computer program stored thereon which, when loaded into a computer, analyzes luminescent signals on a surface comprising a plurality of luminescent signal producing features, said computer program performing steps comprising:
(a) exciting under computer control said luminescent signal producing features,
(b) detecting under computer control luminescent signal emitted from each of said signal producing features wherein said luminescent signal is detected using at least two predetermined integration periods, I and Q, that are offset by ninety degrees with respect to the fundamental excitation frequency employed in step (a), and
(c) determining under computer control the characteristics of said luminescent signal by processing said luminescent signals detected during said at least two integration periods.

24. A computer program product according to claim 23 wherein said detecting of step (b) is carried out by means of an area sensor detector under computer control.

25. A computer program product according to claim 24 wherein said area sensor detector is selected from the group consisting of CCD detectors and CMOS detectors.

26. A computer program product according to claim 23 wherein the processing of step (c) is carried out by calculating under computer control the square root of the sum of the squares to determine the amplitude of said fluorescent signal and calculating under computer control the arctangent of the quotient of I and Q to determine the phase of said fluorescent signal.

27. A computer program product according to claim 23 wherein said luminescent signal is fluorescence.

28. A computer program according to claim 23 wherein the start of said integration periods occurs during a predetermined fraction of the cycle of said luminescent signal emission and is selected to obtain a vector wherein the contribution of I to said vector is maximized and the contribution of Q to said vector is minimized.
